(19) United States
(12) Patent Application Publication
(10) Pub. No.: US 2008/0231673 A1
(43) Pub. Date: Sep. 25, 2008

(54) INKJET PRINTERS

(75) Inventor: Shr-How Huang, Taipei City (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 12/050,606

(22) Filed: Mar. 18, 2008

(30) Foreign Application Priority Data
Mar. 19, 2007 (TW) TW96109306

(51) Int. Cl. B41J 2/175

(52) U.S. Cl. 347/85

(57) ABSTRACT

Inkjet printers are provided. An inkjet printer includes a maintenance module, an inkjet unit, a pump, a slider, and a swing gear assembly. The swing gear assembly is connected to a motor of the pump and detachably engaged with the slider. When the motor rotates the swing gear assembly in a first direction to a first angle, the swing gear assembly is engaged with the slider, and the swing gear assembly impels the slider from an initial position to a first position to open the valve. When the motor rotates the swing gear assembly in a second direction to a second angle, the swing gear assembly is engaged with the slider, to separate the slider from the first position and close the valve.

### BACKGROUND OF THE INVENTION

1. Field of the Invention

The invention relates in general to printers and in particular to inkjet printers.

2. Description of the Related Art

Conventional inkjet printers commonly utilize inkjet cartridges typically including an ink tank and a print head integrated therewith. However, the integrated inkjet cartridges are costly and uneconomical because they can not be reused or refilled with ink. Another type of inkjet printers utilize separate ink tank and print head. When the print head fails or the ink tank is empty, the ink tank and the print head can be replaced individually. To prevent the need for replacement of the ink tank and the print head, a continuous ink supply system is desirable.

### BRIEF SUMMARY OF THE INVENTION

Inkjet printers are provided. An inkjet printer includes a maintenance module, an inkjet unit, a pump, a slider, and a swing gear assembly. The swing gear assembly is connected to a motor of the pump and detachably engaged with the slider. When the motor rotates the swing gear assembly in a first direction to a first angle, the swing gear assembly is engaged with the slider, and the swing gear assembly impels the slider from an initial position to a first position to open the valve. When the motor rotates the swing gear assembly in a second direction to a second angle, the swing gear assembly is engaged with the slider and separates the slider from the first position to close the valve.

### BRIEF DESCRIPTION OF THE DRAWINGS

The invention can be more fully understood by reading the subsequent detailed description and examples with references made to the accompanying drawings, wherein:

FIG. 1 is a perspective diagram of an inkjet printer when a slider is in an initial position;

FIG. 2 is a perspective diagram of an inkjet printer when a swing gear assembly rotates from a first angle to a second angle;

FIG. 3A is a perspective diagram of a carrier in position Z1;

FIG. 3B is a perspective diagram of the carrier in FIG. 3A moving form position Z1 to position Z2;

FIG. 4 is a perspective diagram of a swing gear assembly impelling a slider to a first position;

FIG. 5 is a perspective diagram of a swing gear assembly contacting a stopper of a carrier;

FIG. 6 is a perspective diagram of a swing gear assembly rotating to a first angle; and

FIG. 7 is a perspective diagram of a swing gear assembly impelling a slider to a second position.

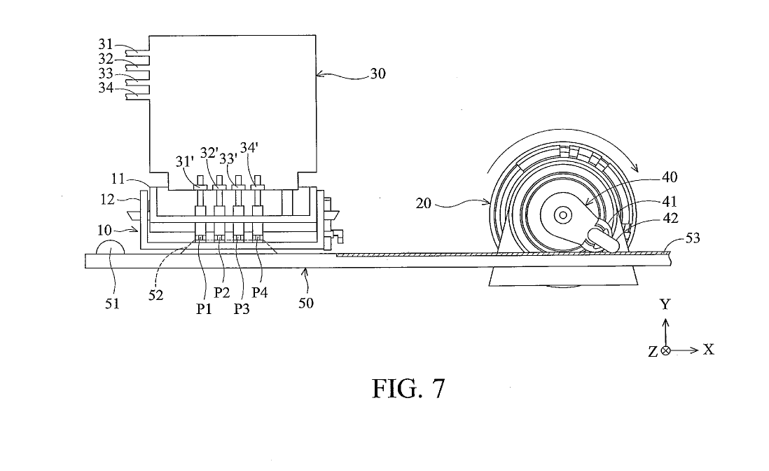

### DETAILED DESCRIPTION OF THE INVENTION

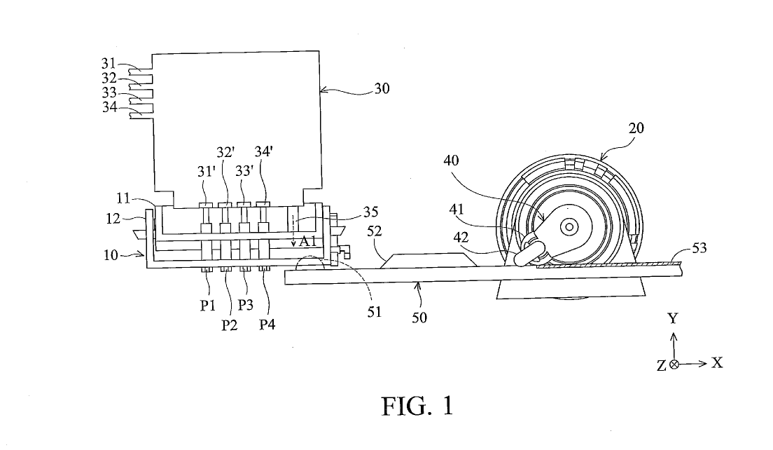

Referring to FIG. 1, an embodiment of an inkjet printer primarily comprises a maintenance module 10, a pneumatic pump 20, an inkjet unit 30, a swing gear assembly 40 separately coupled with a motor of the pump 20, and a slider 50. As shown in FIG. 1, the maintenance module 10 comprises a base 12 and a carrier 11 movably disposed thereon for sustaining the inkjet unit 30. The inkjet unit 30 comprises an interior ink reservoir (not shown) partitioned into four chambers respectively accommodating cyan, magenta, yellow, and black inks. The four color inks can be transferred from an external ink tank (not shown) to the ink reservoir through four conduits 11-14, respectively. The inkjet unit 30 further comprises a print head (not shown) disposed on the bottom side thereof and communicated with the ink reservoir for inkjet printing. When printing on a medium, such as a paper sheet, the inkjet unit 30 is separated from the maintenance module 10. When any color ink runs out during printing, the inkjet unit 30 returns to the top of the maintenance module 10 and connects the carrier 11 for ink replenishment, as shown in FIG. 1.

In this embodiment, the inkjet unit 30 comprises four tappets P1-P4 movably disposed through the carrier 11 and respectively connected to four valves 31′-34′ of the inkjet unit 30. When the four valves 31′-34′ are open, the pump 20 vacuums the inkjet unit 30 from a passage 35 through the carrier 11, as the arrow A1 indicates in FIG. 1, such that the four color inks are drawn from the ink tank to the ink reservoir via conduits 31-34.

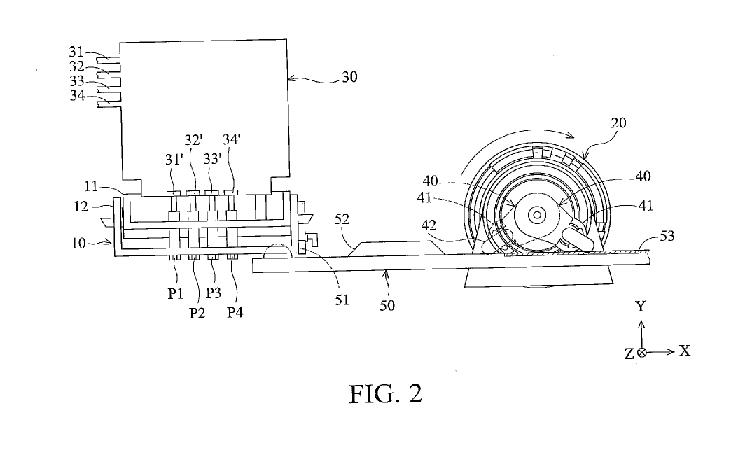

Before supplying ink to the ink reservoir, the swing gear assembly 40 is at a first angle, as shown in FIG. 1, wherein the slider 50 is in an initial position and separated from the tappets P1-P4. Here, the valves 31′-34′ are closed to prevent ink transmission from the ink tank to the ink reservoir. When refilling the ink reservoir, as shown in FIG. 2, the motor of the pump 20 rotates in a first direction (clockwise) and impels the swing gear assembly 40 from the first angle to a second angle, such that a driven gear 41 of the swing gear assembly 40 meshes with a rack 53 of the slider 50.

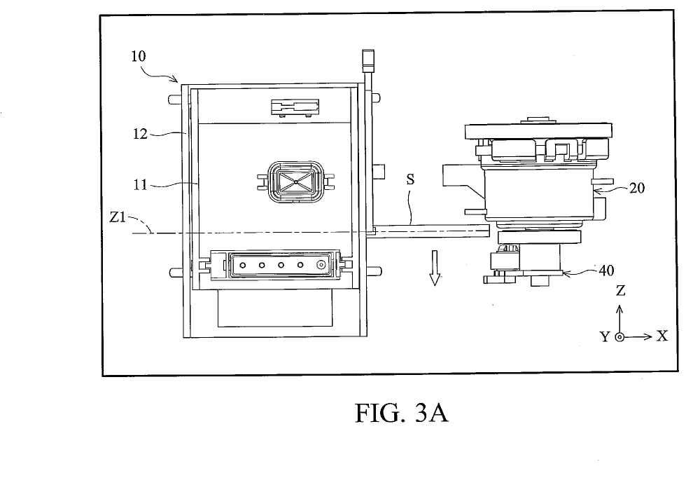

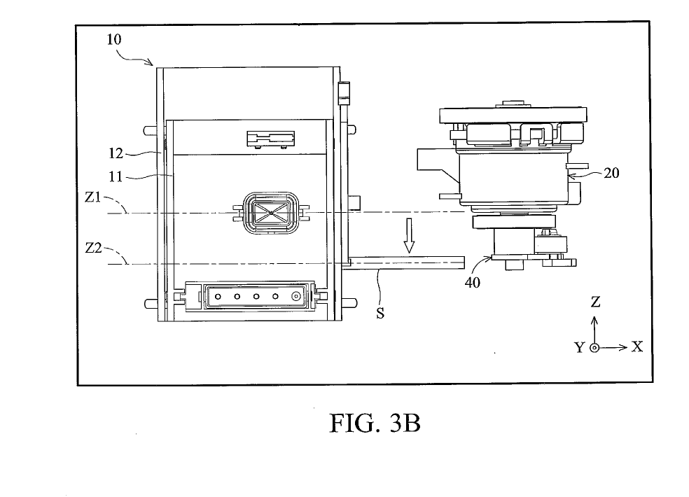

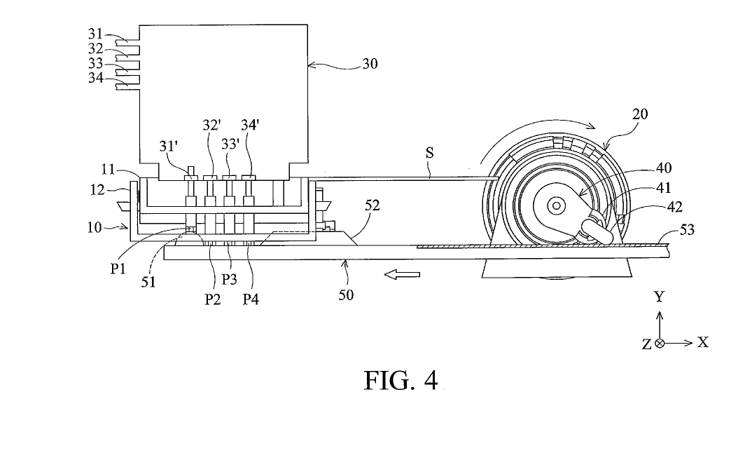

During rotation of the swing gear assembly 40 from the first angle to the second angle, the carrier 11 moves with respect to the case 12 along X axis from position Z1 (FIG. 3A) to a refill position Z2 (FIG. 3B). Hence, a longitudinal stopper S of the carrier 11 is situated in a rotation plane of the swing gear assembly 40, as shown in FIG. 3B. Referring to FIG. 4, as the driven gear 41 meshes with the rack 53 of the slider 50, the swing gear assembly 40 impels the slider 50 leftward to a first position by the motor rotating in the first direction (clockwise), such that a first protrusion 51 of the slider 50 pushes the tappet P1 upward and opens the valve 31′.

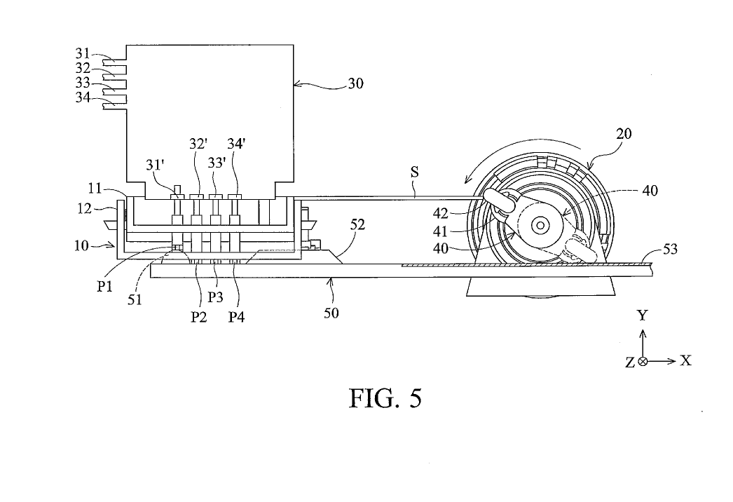

Referring to FIG. 5, when the valve 31′ is open, the motor of the pump 20 reversely rotates along a second direction (counterclockwise), such that ink is drawn from the ink tank to the ink reservoir of the ink unit 30. Meanwhile, the swing gear assembly 40 is rotated with the motor counterclockwise to a third angle, as shown in FIG. 5, such that a contact portion 42 of the swing gear assembly 40 contacts the stopper S, to prevent engagement between the swing gear assembly 40 and the rack 53. Hence, the slider 50 is stationary in the first position, and the valve 31′ remains open to complete ink replenishment of the ink reservoir.

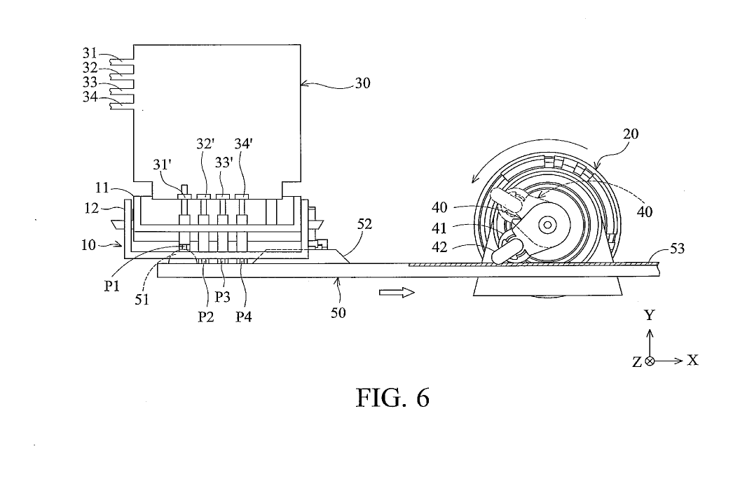

When ink replenishment is complete, the carrier 11 returns from the refill position Z2 to position Z1 (FIG. 3A), and the stopper S departs from the rotation plane of the swing gear assembly 40. Subsequently, the swing gear assembly 40 is released and rotated with the motor counterclockwise to the first angle and engaged with the rack 53 of the slider 50, as shown in FIG. 6. Finally, the swing gear assembly 40 impels the slider 50 to the initial position, such that the valves 31′-34′ are closed. Specifically, when the slider 50 moves to the initial position, as shown in FIG. 1, the swing gear assembly 40 is disengaged from the rack 53, such that the slider 50 is stationary in the initial position, and the valves 31′-34′ remain closed.

In this embodiment, the slider 50 is driven by the swing gear assembly 40 along X axis to selectively open different valves 31′-34 for conducting cyan, magenta, yellow, or black color ink into the ink reservoir. As shown in GIF. 7, the swing gear assembly 40 can also impel the slider 50 to a second position, such that a second protrusion 52 of the slider 50 pushes all the tappets P1-P4 upward and opens all valves 31′-34′ to simultaneously conduct cyan, magenta, yellow, and black color inks into the ink reservoir.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An inkjet printer, comprising:
a maintenance module;
an inkjet unit, separately connecting to the maintenance module and comprising an ink reservoir, wherein the ink reservoir comprises a valve;
a pump, comprising a motor;
an ink tank, communicating with the ink reservoir, wherein the pump conducts ink from the ink tank to the ink reservoir when the valve is open;
a tappet, disposed on the maintenance module and movably connected to the valve;
a slider, comprising a first protrusion pushing the first tappet and opening the valve when slider moves to a first position; and
a swing gear assembly, connected to the motor and detachably engaged with the slider;
wherein when the motor rotates the swing gear assembly in a first direction to a first angle, the swing gear assembly is engaged with the slider, and the swing gear assembly impels the slider from an initial position to the first position to open the valve;
wherein when the motor rotates the swing gear assembly in a second direction to a second angle, the swing gear assembly is engaged with the slider to separate the slider from the first position and close the valve.

2. The inkjet printer as claimed in claim 1, the maintenance module comprising a base and a carrier movably disposed thereon, wherein the carrier sustains the inkjet unit, and the tappet is movably disposed on the carrier.

3. The inkjet printer as claimed in claim 2, the carrier comprising a stopper, wherein when the slider moves from the initial position to the first position, the carrier moves to a refill position, and the stopper is situated in a rotation plane of the swing gear assembly.

4. The inkjet printer as claimed in claim 3, the swing gear assembly comprising a contact portion, wherein when the carrier moves to the refill position and the valve is open, the motor rotates in the second direction and impels the swing gear assembly to a third angle, such that the contact potion contacts the stopper to prevent engagement between the swing gear assembly and the slider.

5. The inkjet printer as claimed in claim 4, wherein the third angle is between the first and second angles.

6. The inkjet printer as claimed in claim 4, wherein when the carrier is in the refill position and the valve is open, the motor rotates in the second direction to draw ink from the ink tank to the ink reservoir.

7. The inkjet printer as claimed in claim 1, wherein the slider comprises a rack, and the swing gear assembly impels the slider to the initial position by engaging with the rack at the second angle.

8. The inkjet printer as claimed in claim 7, wherein when the slider moves to the initial position, the swing gear assembly is disengaged from the rack, such that the slider is stationary in the initial position.

9. The inkjet printer as claimed in claim 1, the slider further comprising a second protrusion, the ink reservoir comprising a plurality of valves, the maintenance module comprising a plurality of tappets corresponding to the valves, wherein the swing gear assembly impels the slider to a second position when in the first angle, and the second protrusion pushes the tappets to open the valves.
